(19) United States
(12) Patent Application Publication
(10) Pub. No.: US 2006/0074518 A1
(43) Pub. Date: Apr. 6, 2006

(54) Apparatus and/or method of controlling image forming apparatus

(75) Inventor: Hyun-soo Song, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/205,059

(22) Filed: Aug. 17, 2005

(30) Foreign Application Priority Data
Sep. 9, 2004 (KR) 10-2004-0072080

(51) Int. Cl. G06F 7/00

(52) U.S. Cl. 700/213

(57) ABSTRACT

A method of controlling an image forming apparatus is provided. The method includes transferring control information of a second driving source from a body into an optional cassette by a first control unit; re-transferring the control information of the second driving source from the body into the optional cassette by the first control unit if an interface error is occurred between the body and the optional cassette; and driving the second driving source before driving a pick-up roller of the optional cassette if the first control unit and/or the second control unit determines it is a point of time to drive the pick-up roller of the optional cassette.

### CROSS-REFERENCE TO RELATED APPLICATION

This application claims the benefit of Korean Patent Application No. 10-2004-0072080, filed on Sep. 9, 2004, in the Korean Intellectual Property Office, the disclosure of which is incorporated herein in its entirety by reference.

### BACKGROUND OF THE INVENTION

1. Field of the Invention

The present invention relates to a method of controlling an image forming apparatus, and more particularly, a method of controlling an image forming apparatus to control jam occurred in an optional cassette by an interface error between a body and the optional cassette.2.

2. Description of the Related Art

Generally, an electrophotographic image forming apparatus for printing a monochrome or color image, by scanning light onto a photosensitive medium electrified with a predetermined electric potential to form an electrostatic latent image, developing the electrostatic latent image by a predetermined color toner using a developing unit, transferring and mounting the determined latent image on paper, and printing the same.

The electrophotographic image forming apparatus is classified broadly into a liquid electrophotographic printer and a dry electrophotographic printer depending on a developing agent. The liquid electrophotographic printer uses a developing agent in which a powdered toner is dispersed in a liquefied carrier. The dry electrophotographic printer uses a two-element developing agent including mixed powdered carrier and toner or one-element developing agent having no carrier. The dry electrophotographic printer is explained below, and for convenience's sake, the developing agent is hereinafter called a toner.

The image forming apparatus includes a body cassette for loading paper on which image is formed, picks up a single sheet of the paper loaded on the main cassette and transfers and fuses the image on the paper so as to form a desired image. The main cassette has predetermined capacity of loading a number of papers. Therefore, if all of the paper loaded in the body cassette is used, other paper have to be loaded in the main cassette.

As the case may be, when a different kind of paper needs to be used, there is the inconvenience of removing the paper loaded in the main cassette and loading the different paper in the main cassette. Therefore, an optional cassette is additionally provided to the main cassette. The optional cassette is loaded with the different kind of paper and mounted in a body to be interfaced from each other. By selecting the optional cassette as needed, it becomes easy to use the different kind of paper as desired.

The body is provided with a main control unit for generally controlling the image forming apparatus, a pick-up roller for picking up a single sheet of paper, and a transfer roller for transferring the single sheet of paper picked up. The optional cassette is also provided with an optional cassette control unit, a pick-up roller and a transfer roller.

The pick-up roller and the transfer roller are connected with a sub-drive unit to be driven, and the pick-up roller is driven to pick up paper at predetermined time only as it is interfered by a pick-up roller drive unit. Although the pick-up roller is connected with the sub-drive unit, it is not driven when it is interfered by the pick-up roller drive unit (for example, pick-up solenoid). The pick-up roller is driven to pick up paper only for the predetermined time by means of the power transferred from the sub-drive unit when the interference is removed.

To select the optional cassette to pick up the paper loaded in the optional cassette, the main control unit transmits the motor control information (information regarding direction, step, electric current and speed) of the optional cassette into an optional cassette control unit, and the optional cassette control unit drives the sub-drive unit of the optional cassette and the pick-up roller drive unit.

However, when an interface error, such as loose contact with the body or occurrence of a noise in a signal line, is occurred between the main control unit and the optional cassette control unit, the main control unit re-transmits the control information of the sub-drive unit of the optional cassette after the interface error is detected. This is prepared for the case where the optional cassette control unit loses the control information of the sub-drive unit of the optional cassette, which was already transferred from the main control unit.

Then, a command to drive the pick-up roller drive unit of the optional cassette is transferred. At this time, the sub-drive unit of the optional cassette is stopped as the interface error occurs.

In the state that the sub-drive unit of the optioned cassette is stopped, if the main control unit transfers the command to drive the pick-up roller drive unit of the optional cassette into the optional cassette control unit, only the pick-up roller drive unit is driven in the optional cassette in the state that the pick-up roller and the transfer roller are not driven. As a result, the paper is not transferred into the body within the predetermined time and therefore it is recognized that jam is occurred.

That is, when the interface error occurs, the paper jam occurs, without determining whether the sub-drive unit operates, by operating the pick-up roller drive unit only.

### SUMMARY OF THE INVENTION

Additional aspects and/or advantages of the invention will be set forth in part in the description which follows and, in part, will be apparent from the description, or may be learned by practice of the invention.

The present invention provides a method of controlling an image forming apparatus to prevent paper from being jammed by driving a sub-drive unit of an optional cassette before a pick-up drive unit is driven when an interface error occurs between a body and the optional cassette.

According to an aspect of the present invention, there is provided a method of controlling an image forming apparatus which includes a body with a first control unit and a first driving source and an optional cassette with a second control unit and a second driving source. The method includes transferring control information of a second driving source from the body into the optional cassette by the first control unit; if an interface error occurs between the body and the optional cassette, re-transmitting the control information of the second driving source from the body into the optional cassette by the first control unit; and if the first control unit and/or the second control unit determines it is time to drive a pick-up roller of the optional cassette, driving the second driving source before the pick-up roller of the optional cassette is driven.

### BRIEF DESCRIPTION OF THE DRAWINGS

These and/or other aspects and advantages of the invention will become apparent and more readily appreciated from the following description of the embodiments, taken in conjunction with the accompanying drawings of which:

These and/or other aspects and advantages of the invention will become apparent and more readily appreciated from the following description of the embodiments taken in conjunction with the accompanying drawings in which:

FIG. 1 is a side cross-sectional view illustrating image forming apparatus according to an aspect of the present invention;

FIG. 2 is a block diagram illustrating a circuit of an image forming apparatus to perform a method for controlling an image forming apparatus according to the present invention;

FIG. 3 is a flow chart to perform a method for controlling an image forming apparatus according to one embodiment of the present invention; and

FIG. 4 is a flow chart to perform a method for controlling an image forming apparatus according to another embodiment of the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the thickness of layers and regions are exaggerated for clarity. Like numbers refer to like elements throughout the specification.

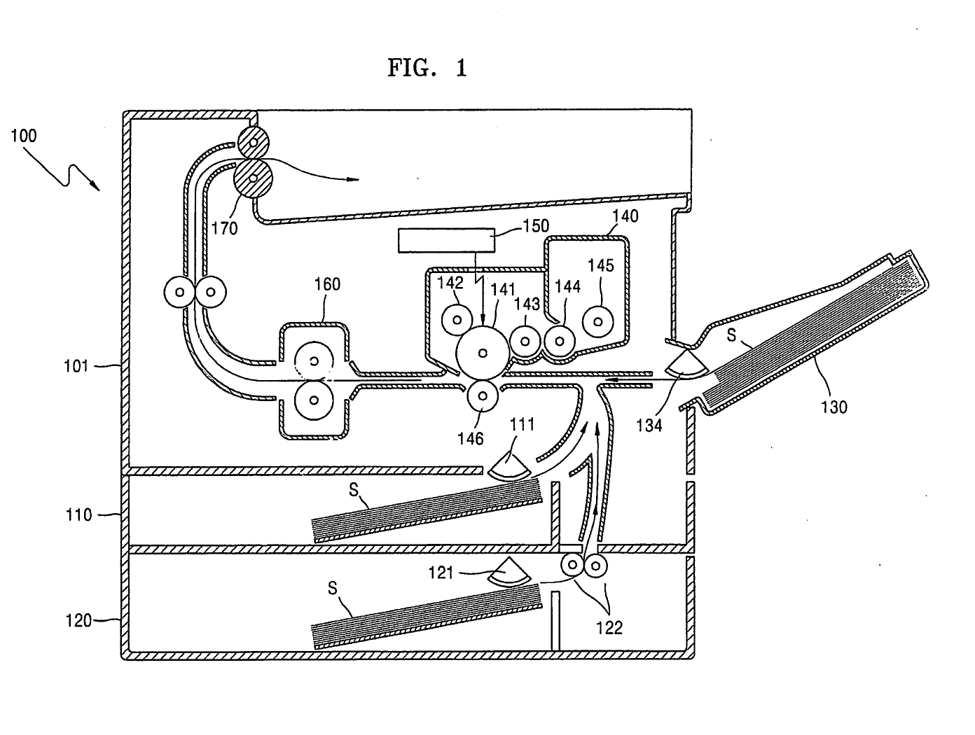

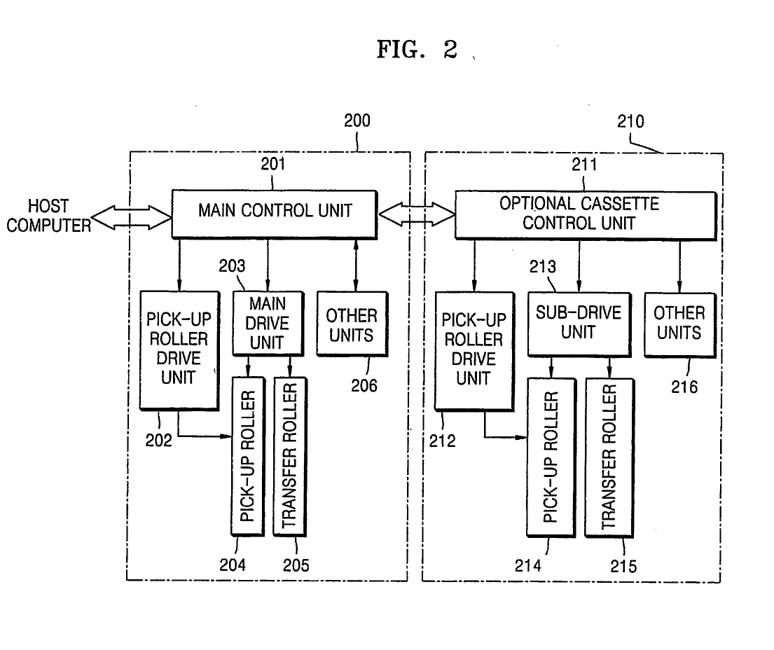

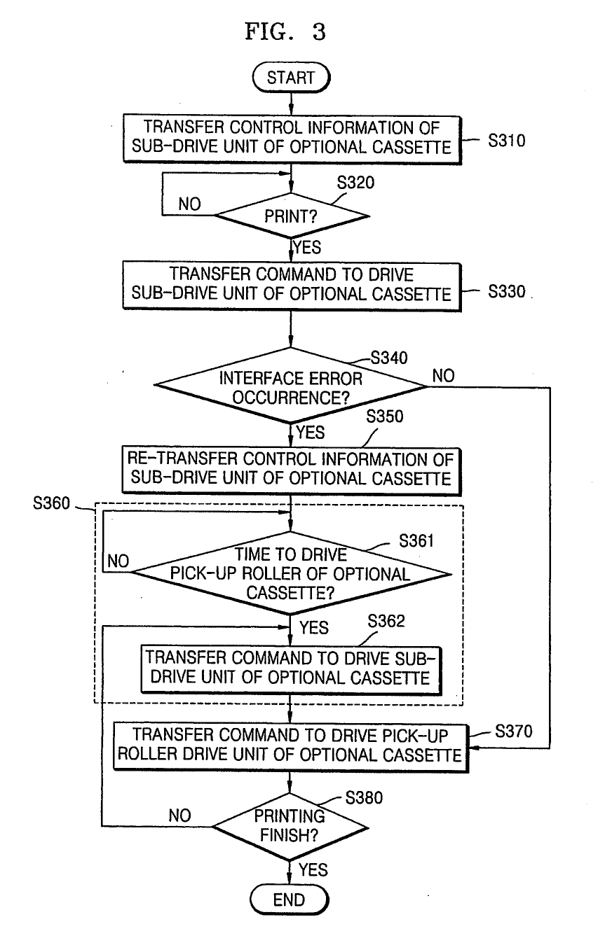

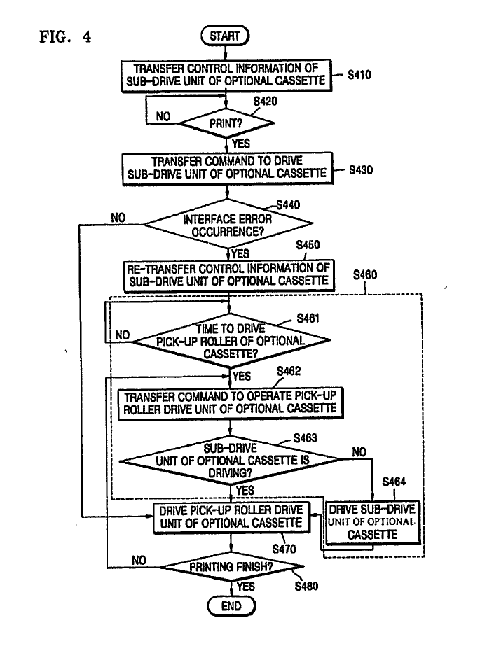

FIG. 1 is a side cross-sectional view illustrating an image forming apparatus to which a method of controlling according to an embodiment of the present invention; FIG. 2 is a block diagram illustrating a circuit of an image forming apparatus to perform a method for controlling an image forming apparatus according to the present invention; FIG. 3 is a flow chart to perform a method for controlling an image forming apparatus according to an embodiment of the present invention, and FIG. 4 is a flow chart to perform a method for controlling an image forming apparatus according to another embodiment of the present invention.

Referring to FIG. 1, an image forming apparatus 100 includes a body 101 including a printing unit and an optional cassette 120 for loading paper S, the optional cassette 120 mounted in the body 101.

In the body 101, a main cassette 110 loaded with paper S is attachably and detachably installed, and a multipurpose paper feeder 130 for loading the paper S is installed in one side of the body 101. On the upper sides of the optional cassette 120, the main cassette 110 and the multipurpose paper feeder 130, pick-up rollers 121, 111, 134 are installed for picking up a sheet of the paper S one by one by selectively contacting with the paper S.

The paper S as pick up by the pick-up rollers 121, 111, 134 are transferred along a transfer route, an image is formed on the paper S by a developing unit 140 provided on the transfer route, and the image is fused on the paper S by a transfer unit 160.

The developing unit 140 includes a photosensitive medium 141 for forming an electrostatic latent image by generating an electric potential difference on the surface by the light applied by an exposing unit 150 such as a laser scanning unit, a developing roller 143 for developing the electrostatic latent image formed on the photosensitive medium 141 by using a toner, an agitating roller 145 for agitating the toner as stored not to be hardened, and a supplying roller 144 for supplying the developing roller 143 with the toner as stored.

Opposite to the photosensitive medium 141, a transfer roller 146 is installed to be contact with the photosensitive medium 141. The transfer roller 146 transfers the image formed on the photosensitive medium 141 into the paper S by pushing and pressing the paper S passing through the contact side to the photosensitive medium 141.

A fusing unit 160 fuses the image on the paper S by applying heat and pressure to the image transferred into the paper S. The paper S on which the image is fused passes through a paper ejecting roller 170 to be output.

Referring to FIG. 2, the circuit of an image forming apparatus includes body circuit constitution 200 and optional cassette circuit constitution 210.

The body circuit 200 includes a main control portion 201 for generally controlling a plurality of units a body. The main control unit 201 controls a main drive unit 203 for providing power to operate a pick-up roller 204 and a transfer roller 205, a pick-up roller drive unit 202 for interfering the pick-up roller 204, and other units 206 such as a sensor.

The optional cassette circuit 210 includes an optional cassette control unit 211 for controlling a sub-drive unit 213 to provide power to operate a pick-up roller 214 and a transfer roller 215, a pick-up roller drive unit 212 for interfering the pick-up roller 214, and other units 216 such as a sensor.

In the body circuit 200 and the optional cassette circuit 210, the main control unit 201 and the optional cassette control unit 211 are connected with each other. The main control unit 201 of the body circuit 200 is also connected with a host computer.

A method for controlling an image forming apparatus according to an embodiment of the present invention is explained with reference to the drawings.

Referring to FIGS. 1 to 3, if an image signal is transmitted from the host computer, the main control unit 201 controls the pick-up roller drive unit 202, the main drive unit 203 and other units 206 to form an image on the paper S loaded in the body cassette 110.

Meantime, when an image is formed on the paper S loaded in the optional cassette 120 by receiving the image signal from the host computer, the main control unit 201 transfers the control information of the sub-drive unit of the optional cassette into the optional cassette control unit 211 (S310).

The main control unit 201 determines whether to print (S320). If the main control unit 201 determines to print at operation 320, a command to drive the sub-drive unit of the optional cassette 120 is transmitted into the optional cassette control unit 211 (S330).

Then, the optional cassette control unit 211 drives the sub-drive unit 213 by the driving command, and the power is transferred into the pick-up roller 214 and the transfer roller 215 as connected. The transfer roller 215 is rotated by the power as transferred but the pick-up roller 214 is interfered by the pick-up roller drive unit (for example, pick-up solenoid) so that the power is in a state of interruption.

However, if the main control unit 201 determines not to print at operation 320, it is returned to operation 320.

The main control unit 201 transfers the command to drive the sub-drive unit 213 of the optional cassette 120 into the optional cassette control unit 211 (S330). The main control unit 201 determines whether an interface error occurs between the body 101 and the optional cassette 120 (S340).

If the interface error occurs between the body 101 and the optional cassette 120, the main control unit 201 re-transmits the control information of the sub-drive unit of the optional cassette 120 into the optional cassette control unit 211 after the interface error is checked (S350). This is prepared for the case where the control information of the sub-drive unit already transmitted into the optional cassette control unit 211 is lost by the interface error occurred between the body 101 and the optional cassette 120. If the interface error occurs between the body 101 and the optional cassette 120, the sub-drive unit 213 stops driving and is in a state of stop. Then, the main control unit 201 determines whether it is a time to drive the pick-up roller 214 (S361).

If the main control unit 201 determines it is the time to drive the pick-up roller 214 of the optional cassette 120 at operation 361, the command to drive the sub-drive unit of the optional cassette 120 is transmitted into the optional cassette control unit 211 (S362). By this, the sub-drive unit 213 is in a state of operation to be same as the state before the interface error occurs.

If the main control unit 201 determines it is not the time to drive the pick-up roller 214 of the optional cassette 120 at operation 361, it is returned to operation 361.

The main control unit 201 drives the sub-drive unit 213 before or at the same time that the pick-up roller drive unit 212 of the optional cassette 120 is driven, thereby preventing jam from being occurred when the paper S is not transferred since the pick-up roller drive unit 212 is driven though the sub-drive unit 213 is not driven. In this connection, operation 361 and operation 362 are an operation of driving a sub-drive unit (S360).

During the pick-up roller drive unit 212 of the optional cassette 120 is driving through the operation of driving the sub-drive unit (S360), the pick-up roller 214 and the transfer roller 215 are consistently driven by the sub-drive unit 213, so that the paper S as pick up by the pick-up roller 214 is transferred into the inside of the body 101 by the transfer roller 215.

After operation 360, the main control unit 201 transfers a command to drive the pick-up roller drive unit 212 of the optional cassette 120 into the optional cassette control unit 211 (S370). By the driving command as transmitted, the pick-up roller 214 is driven to pick up a single sheet of the paper S by the pick-up roller drive unit 212 of the optional cassette 120.

Then, it is determined whether the printing is finished (S380). If the printing is finished, all operations are ended, and if not finished, it is returned to operation 362.

If the main control unit 201 determines that the interface error does not occur between the body 101 and the optional cassette 120 at operation 340, the pick-up roller drive unit 212 of the operation cassette 120 is driven by performing operation 370.

A method for controlling an image forming apparatus according to another embodiment of the present invention is explained with reference to the drawing.

Referring to FIGS. 1, 2 and 4, in case where an image is formed on the paper S loaded in the optional cassette 120 by receiving the image signal from the host computer, the main control unit 201 transfers the control information of the sub-drive unit of the optional cassette 120 into the optional cassette control unit 211 (S410).

The main control unit 201 determines whether to print (S420). If the main control unit determines to print at operation 420, a command to drive the sub-drive unit of the optional cassette 120 is transferred into the optional cassette control unit 211 (S430).

Then, the optional cassette control unit 211 drives the sub-drive unit 213 by the driving command, and the power is transferred into the pick-up roller 214 and the transfer roller 215 as connected. Otherwise, if the main control unit 201 determines not to print at operation 420, it is returned prior to operation 420.

The main control unit 201 determines whether the interface error occurs between the body 101 and the optional cassette 120 (S440).

If the main control unit 201 determines that the interface error occurs between the body 101 and the optional cassette 120, the main control unit 201 re-transmits the control information of the sub-drive unit of the optional cassette 120 into the optional cassette control unit 211 after the interface error is detected (S450). This is prepared for the case where the control information of the sub-drive unit as already transferred is lost by the interface error between the body 101 and the optional cassette 120. When the interface error occurs between the body 101 and the optional cassette 120, the sub-drive unit 213 stops driving and is in a state of stop. Then, the main control unit 201 determines whether it is a time to drive the pick-up roller 214 (S461).

If the main control unit 201 determines that it is the time to drive the pick-up roller 214 of the optional cassette 120, a command to drive the pick-up roller drive unit 212 of the optional cassette 120 is transmitted into the optional cassette control unit 211 (S462).

Otherwise, if the main control unit 201 determines it is not the time to drive the pick-up roller 214 of the optional cassette 120, it is returned to operation 461.

At operation 462, the optional cassette control unit 211 receiving the command to drive the pick-up roller drive unit 212 of the optional cassette 120 from the main control unit 201 determines whether the sub-drive unit 213 of the optional cassette 120 is driving (S463).

If the optional cassette control unit 211 determines that the sub-drive unit 213 of the optional cassette 120 is driving, the optional cassette control unit 211 drives the pick-up roller 121 by driving the pick-up roller drive unit 212 of the optional cassette 120 (S470).

Otherwise, if the optional cassette control unit 211 determines that the sub-drive unit 213 of the optional cassette 120 is not driving, the optional cassette control unit 211 drives the sub-drive unit 213 of the optional cassette 120 (S464).

Even though a command to operate the pick-up roller drive unit 212 of the optional cassette 120 is transmitted from the main control unit 201 into the optional cassette control unit 211, the optional cassette control unit 211 first determines whether the sub-drive unit 213 of the optional cassette 120 is driving before performing operating the command. Then, the optional cassette control unit 212 drives the sub-drive unit 213 before or at the same time that the pick-up roller drive unit 212 of the optional cassette 120 is operated, thereby preventing jam from being occurred when the paper S is not transferred by driving the pick-up roller drive unit 212 even though the sub-drive unit 213 is not driven. In this connection, operations 461 to 464 are operations for driving the sub-drive unit (S460).

After operation 460, the main control unit 210 transfers a command to drive the pick-up roller drive unit 212 of the optional cassette 120 into the optional cassette control unit 211 (S470). Then, whether printing is finished is determined (S480), and if the printing is finished, all operations are ended, and otherwise, it is returned to operation 462.

At operation 440, if the main control unit 201 determines that the interface error does not occur between the body 101 and the optional cassette 120, the main control unit 201 performs operation 470 to drive the pick-up roller drive unit 212 of the optional cassette 120.

As described in detail, a method of controlling an image forming apparatus according to the present invention has effects of preventing a jam from being occurred when the paper is not transferred, by operating the sub-drive unit of the optional cassette before driving the pick-up roller of the optional cassette, thereby providing a user with an easy and efficient image forming apparatus.

While the present invention has been particularly shown and described with reference to exemplary embodiments thereof, it will be understood by those of ordinary skill in the art that various changes in form and details may be made therein without departing from the spirit and scope of the present invention as defined by the following claims.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of controlling an image forming apparatus which comprises a body with a first control unit and a first driving source and an optional cassette with a second control unit and a second driving source, the method comprising:
transferring control information of the second driving source from the body into the optional cassette;
re-transferring the control information of the second driving source from the body into the optional cassette if an interface error is occurred between the body and the optional cassette; and
driving the second driving source before driving a pick-up roller of the optional cassette if the first control unit and/or the second control unit determines it is a time to drive the pick-up roller of the optional cassette.

2. The method of claim 1, wherein the operation of controlling the second driving source further comprises:
determining whether it is a point of time to drive the pick-up roller of the optional cassette; and
transferring a command to drive the second driving source if it is determined as the point of time to drive the pick-up roller of the optional cassette at the determining.

3. The method of claim 1, further comprising transferring a command to drive a pick-up roller drive unit of the optional cassette after the operation of driving the second driving source.

4. The method of claim 1, wherein the operation of driving the second driving source is performed by the first control unit.

5. The method of claim 1, wherein the operation of driving the second driving source comprises:
determining whether it is a point of time to drive the pick-up roller of the optional cassette;
transferring a command to drive the pick-up roller drive unit of the optional cassette if it is determined as the point of time to drive the pick-up roller;
determining whether a sub-drive unit of the optional cassette is driving; and
driving the sub-drive unit of the optional cassette if it is determined that the sub-drive unit of the optional cassette is not driving.

6. The method of claim 5, further comprising driving the pick-up roller drive unit of the optional cassette after the operation of driving the second driving source.

7. The method for claim 5, wherein the operation of determining whether the sub-drive unit of the optional cassette is driving and the operation of driving the sub-drive unit of the optional cassette are performed by the second control unit.

8. The method for claim 1, further comprising transferring a command to drive the sub-drive unit of the optional cassette after the operation of transferring the control information of the sub-drive unit of the optional cassette.

9. A method of controlling an image forming apparatus, the method comprising:
transmitting control information; and
driving a driving source prior to drive a pick-up roller of the optional cassette in accordance with the transmitted control information.

10. The method of claim 9, the method further comprises:
checking the transmitting control information error; and
re-transmitting if transmitting control information error occurs.

11. An apparatus for forming an image having an optional cassette control unit, the apparatus comprising:
a sub-drive unit driving the optional cassette control unit;
a pick-up roller drive unit for controlling the sub-drive unit; and
the sub-drive unit controlling the pick-up roller unit,
wherein the pick-up roller unit is driven by the sub-drive unit before a paper is transferred.

12. An apparatus for forming an image having an optional cassette unit, the apparatus comprising:
a main control unit controlling printing operations; and
a driving unit controlling the optional cassette unit;
wherein the main control unit check whether an interface error occurs transferring an optional cassette control signal and retransmitting the optional cassette control signal if the interface error occurred.
